(19) United States
(12) Patent Application Publication
(10) Pub. No.: US 2019/0270126 A1
(43) Pub. Date: Sep. 5, 2019

(54) Method and System of Removing Debris From Piping in a High-Rise Building Plumbing Network

(71) Applicant: Daniel Grenier, Sarasota, FL (US)

(72) Inventor: Daniel Grenier, Sarasota, FL (US)

(21) Appl. No.: 16/418,749

(22) Filed: May 21, 2019

Related U.S. Application Data
(63) Continuation-in-part of application No. 14/330,879, filed on Jul. 14, 2014, now Pat. No. 10,301,804.
(60) Provisional application No. 61/957,814, filed on Jul. 12, 2013.

(51) Int. Cl. B08B 9/049; B08B 9/053

(52) U.S. Cl. CPC B08B 9/0495; B08B 9/053; B08B 2209/053; B08B 2209/032; B08B 2209/022

(57) ABSTRACT

A method and system for removing debris from drainage lines in high rise building uses a high pressure water line terminated by a head having one or more backwards-facing nozzles. The thrust force creates at the backward-facing nozzle(s) is sufficient to propel the head and water line vertically up a drainage line. An operates can control the head and, with the assistance of a video system used with the head, maneuver the head along the line, into single stack aerator fittings, and into and along horizontal lines connected to the single stack aerator fittings. The force of the water exiting the nozzle(s) on the head both dislodges debris in the drainage line and fittings, and urges it downstream back to the access point where the head was inserted into the drainage line.

### CROSS-REFERENCE TO RELATED APPLICATION

This application claims priority to U.S. Provisional Patent Application No. 61/957,814 filed Jul. 12, 2013, and is a continuation in part of U.S. patent application Ser. No. 14/330,879, filed Jul. 14, 2014, the entireties of which is incorporated by reference.

### FIELD OF THE INVENTION

The present invention relates generally to a method and system for removing debris from piping and, more particularly, relates to a method and system for removing debris from single stack drain piping in high-rise building plumbing systems with a camera, pressure source, and vacuum.

### BACKGROUND OF THE INVENTION

It is well known that plumbing systems in high-rise buildings, i.e., buildings with at least eight to ten floors, experience numerous drainage problems, such as clogged drains and piping. This is chiefly due to the type of piping used in said buildings. More specifically, many high-rise buildings utilized piping with an internal geometry designed to balance pressures inside the plumbing system. This geometry has a disadvantage, however, of being prone to clogging because of the extreme curves and impasses disposed therein. This problem is not only prevalent in high-rise buildings, however, as many other types of buildings also experience draining issues with their plumbing systems because of similar issues.

A known method for removing debris from piping includes the application of chemical drain cleaners to the piping. Chemical drain cleaners are available in solid or liquid form. Unfortunately, chemical drain cleaners are not always effective for removing debris, especially when the debris is a solid obstruction. Furthermore, many chemical drain cleaners are dangerous and may cause damage to a user's eyes, lungs, and skin.

Another known method for removing debris from piping includes uses mechanical action, via a rigid apparatus known in the art as a “snake,” to move the clogged debris. Many known snakes are limited in length and size thereby rendering them ineffective for clogs disposed far downstream of the drain or inoperable to navigate around certain bends in a plumbing system. Moreover, in many instances the snake simply transports the clogged debris further downstream so as to create the same problem it was intended to solve. This is especially true for the above-described geometry used in many high-rise buildings.

Some known systems also utilize a pressure source, a vacuum, and a hose to apply varying amounts of pressure and suction to the clogged piping. The hose is normally inserted into the piping and must be equipped with an attachment to produce a tight fit between the hose and the outer drain of the pipe to create a seal. Unfortunately, due to the various sizes and shapes of piping and drains, the attachment may not be appropriately sized for the particular clogged pipe or drain, and may result in air leaking from the connection between the hose and the pipe or drain. Additionally, the amount of air pressure and suction applied to the clogged pipe or drain must be controlled through a controlling mechanism. This is obviously a time intensive task as the air pressure and suction ratio requires constant monitoring. These systems also do not permit the user to monitor the inside of the plumbing to ensure an effective removal of the debris because of the required air-tight configuration with the single opening to which the suction device is attached. Furthermore, this method often results in moving the debris to other areas within the clogged pipe or drain, instead of removing the debris, further complicating the problem.

A common form of drain piping in high rise building is a single stack drain system. Older drain systems use a double or triple stack where each stack is vertically oriented run of piping. In a double stack system, air is vented in one stack is vented into a water/drain stack to ensure passage of air and to prevent hydraulic plugs that can prevent the flow of water and water-carried material. While efficient, and well understood, a double stack system requires room for both stacks, and the piping material is doubled as the two stacks run in parallel to each other.

One way the problem of cost and space required for double stack drainage system has been addressed is by the use of a single stack system. Ordinarily a single stack system would be highly subject to blockage due to the inability of air to pass up past the draining water due to a hydraulic plug. To remedy that issue, inline aerator fittings are used at intervals along the vertical stack in series with a de-aerator fitting at the base of the stack. Typically one such single stack aerator fitting (SSAF) is placed at every floor along the vertical stack. An example of SSAF is sold under the trade name SOVENT.

While single stack systems using SSAFs have proven to be useful in maximizing usable living and other space, and reducing the cost of drainage systems, these systems are also subject to particular issues related to material build-up that can result in blockages. Clearing blockages in SSAFs has proven difficult, if not impossible, using conventional methods. The internal geometry of a SSAF prevents conventional methods and tools from being able to clear blockages in the fitting, as well as accessing the horizontal lines that also need to be cleared.

Therefore, a need exists to overcome the problems with the prior art as discussed above.

### SUMMARY OF THE INVENTION

The invention provides a method of removing debris from pipes in high-rise building plumbing systems that overcomes the hereinafore-mentioned disadvantages of the heretofore-known devices and methods of this general type and that removing debris from piping in a high-rise building plumbing system with a camera, pressure source, and vacuum.

In accordance with some embodiments of the inventive disclosure, there is provided a method of removing debris from a single stack drainage system within a high-rise building. The single stack drainage system includes at least one vertical section including a plurality of single stack aerator fittings, with one single stack aerator fitting at each of a plurality of respective floors of the high-rise building, and wherein each single stack fitting couples to horizontal drain lines at the respective floor. The method includes connecting a y-shaped fitting to an access point connected to the single stack drainage system, the y-shaped fitting having a first branch and a second branch. After connecting the y-shaped fitting, the method further includes inserting a portion of a flexible optical device having a camera into a first one of the first branch of the y-shaped fitting into the single stack drainage system, and inserting a portion of a flexible water conduit into the single stack drainage system through the first branch of the y-shaped fitting. The flexible water conduit having a head, the head having at least one reverse-facing nozzle, and the flexible water conduit being operably coupled to a pressurized water source that provides water at a pressure sufficient to urge the head vertically upstream in the single stack drainage system when the water passes through the at least one reverse-facing nozzle. The method can further include maneuvering the flexible water conduit while providing the water under pressure to the head such that the head travels upstream in the single stack drainage system past debris that is dislodges by the water after passing through the at least one reverse-facing nozzle.

In accordance with another feature, the method can include maneuvering the flexible water conduit into a single stack aerator fitting in the single stack drainage system.

In accordance with another feature, the method can include maneuvering the head through the single stack aerator fitting and into a horizontal drain line connected to the signal stack aerator fitting to remove debris from the horizontal drain line.

In accordance with another feature, the method can include maneuvering the head past a single stack aerator fitting to a vertical section of the single stack drainage system above the signal stack aerator fitting.

In accordance with another feature, the method can include connecting a vacuum pump to the second branch of the y-shaped fitting to remove water and dislodged debris from the single stack drainage system.

In accordance with another feature, the method can include pumping the water and dislodged debris into a debris containment vessel.

In accordance with another feature, the pressurized water source is a pump.

In accordance with another feature, the head carries the camera.

In accordance with some embodiments of the inventive disclosure, there is provided a method of removing debris from a vertical drainage system within a high-rise building, wherein the vertical drainage system includes at least one vertical section including a plurality of vertical aerator connections, and wherein the vertical drainage system couples to at least one horizontal drain line at each floor of the high-rise building. The method can include connecting a y-shaped fitting to an access point connected to the vertical drainage system, the y-shaped fitting having a first branch and a second branch, and after connecting the y-shaped fitting inserting a portion of a flexible optical device having a camera into a first one of the first branch of the y-shaped fitting into the vertical drainage system. The method can further include inserting a portion of a flexible water conduit into the vertical drainage system through the first branch of the y-shaped fitting, the water conduit having a head, the head having at least one reverse-facing nozzle, the water conduit operably coupled to a pressurized water source that provides water at a pressure sufficient to move the head vertically upstream in the vertical drainage system when the water passes through the at least one reverse-facing nozzle. The method can further include maneuvering the flexible water conduit while providing the water under pressure to the head such that the head travels upstream in the vertical drainage system past debris that is dislodges by the water after passing through the at least one reverse-facing nozzle. The method can further include moving the camera in correspondence with the head, and wherein maneuvering the flexible water conduit comprises maneuvering the flexible water conduit based on a video image on a display connected to the camera that is produced by the camera.

In accordance with another feature, the method can further include maneuvering the head into a horizontal drain line upstream of the access point and the at least one vertical section.

In accordance with another feature, the method can further include connecting a vacuum pump to the second branch of the y-shaped fitting to remove water and dislodged debris from the vertical drainage system.

In accordance with another feature, the method can further include pumping the water and dislodged debris into a debris containment vessel.

In accordance with another feature, the pressurized water source is a pump.

In accordance with another feature, the head carries the camera.

In accordance with another feature, the water is pressurized to at least 1500 pounds per square inch.

Although the invention is illustrated and described herein as embodied in a method and system of removing debris from piping within a plumbing system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the piping used in the plumbing system, i.e., the directional flow of fluid in the plumbing system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a fragmentary view of a method of removing debris from piping in high-rise buildings, in accordance with some embodiments;

FIG. 2A is a process flow diagram for illustrating the method of removing debris in accordance with FIG. 1, in accordance with some embodiments;

FIG. 2B is a continuation of the process flow diagram of FIG. 2A illustrating the method of removing debris in accordance with FIG. 1, in accordance with some embodiments;

FIG. 3 is a block diagram of an exemplary implementation of a system of removing debris from piping within a high-rise building plumbing network, in accordance with some embodiments;

FIG. 4 is a fragmentary view of an exemplary plumbing network that includes plumbing members wherein the method in accordance with some embodiments of the present disclosure is carried out;

FIG. 5 is an enlarged cross-sectional view A-A of the plumbing network in FIG. 5;

FIG. 6 shows a single stack system using single stack aerator fittings, in accordance with some embodiments;

FIG. 7 is a schematic diagram of a single stack system using single stack aerator fittings and horizontal offsets, in accordance with some embodiments.

FIG. 8 shows a reverse jet cleaner head used in a single stack system, in accordance with some embodiments; and

FIG. 9 shows a schematic diagram of a cleaning system and method for cleaning a single stack system vertically, in accordance with some embodiments.

### DETAILED DESCRIPTION

While the specification concludes with claims defining the features of the disclosure that are regarded as novel, it is believed that the disclosure will be better understood from a consideration of the following description in conjunction with the drawing figures, in which like reference numerals are carried forward. It is to be understood that the disclosed embodiments are merely exemplary of the disclosure, which can be embodied in various forms.

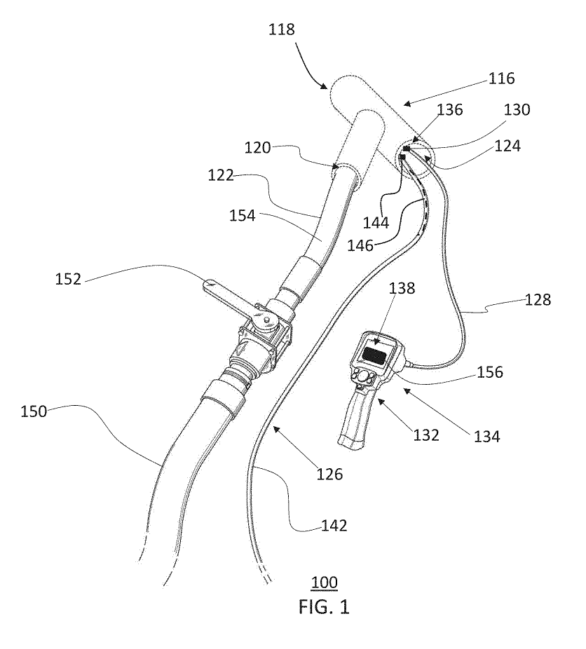

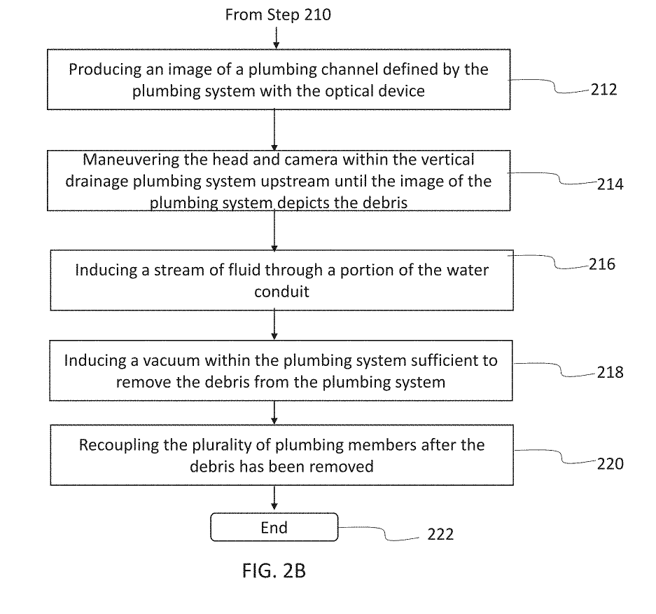

Some embodiments of the present disclosure provide a novel and efficient method and system of removing debris from piping within a high-rise building. In particular, the method and system are useful to dislodge debris in in vertical drainage systems. FIG. 1 depicts a perspective fragmentary view of components utilized in an assembly 100 to carry out the below-described method. FIG. 3 depicts a block diagram showing the aforementioned components, specifically, an optical device 304, a vacuum assembly 306, and a water pressure device 308. With reference to both FIGS. 1 and 3, in some embodiments of the present disclosure the method and system may include first inserting a remote camera 305 of a video viewing device 304 within an opening defined by detaching two piping members within a plumbing system 302 so as not to puncture or damage the piping when attempting to locate the debris. The remote camera 305 of the video viewing device 304 can be at the end of a semi-rigid cable that allows a user to push the remote camera 305 through the piping. In some embodiments the remote camera 305 can be mounted on a head of the water pressure device that is inserted within the piping is designed to maneuver within the piping. Using the video viewing device 304, an image of the inside of the drainage line can be seen on the video viewing device's display screen 138, as well as the head f the water pressure device 308 that has been inserted into the drainage line to facilitate operation of the head using the controlling mechanism 316. Once the debris is identified, in contrast to those known methods that fail to completely remove the debris, the present disclosure provides a method and system that completely removes the debris from the piping using the water pressure device 308 that directs water at the debris for a period of time sufficient to dislodge the debris, and a vacuum caused by the vacuum assembly 306 sufficient to remove the debris from the piping. The water pressure device 308 utilizes a head on a water conduit 126 that can spray jets of water backward (toward the water conduit 126) and outward, at an angle. This can be used to propel the head upward into the piping, along the piping, and can be used to maneuver the head remotely by a user/operator.

FIGS. 1 and 3 show several advantageous features of the present disclosure, but, as will be described below, the disclosure can be provided in several shapes, sizes, combinations of features and components, and varying numbers and functions of the components. FIG. 3 provides both an overview of the system of removing debris from piping within a high-rise building 300 in use and during transport 310. When in use, the system of removing debris from piping within a high-rise building 300 includes a plumbing system or network 302, a video viewing device 304, a vacuum assembly 306 and a water pressure device 308. Advantageously, the system of removing debris from piping within a high-rise building 300 can be transported to various high-rise buildings. When in transport 310 the system of removing debris from piping within a high-rise building 300 may include the vacuum assembly 306, a container 312, a secondary container 314 and the water pressure device 308.

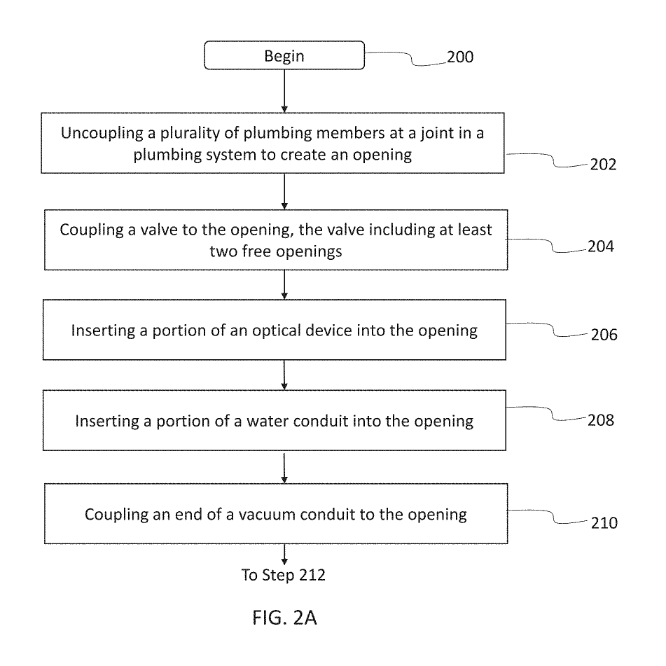

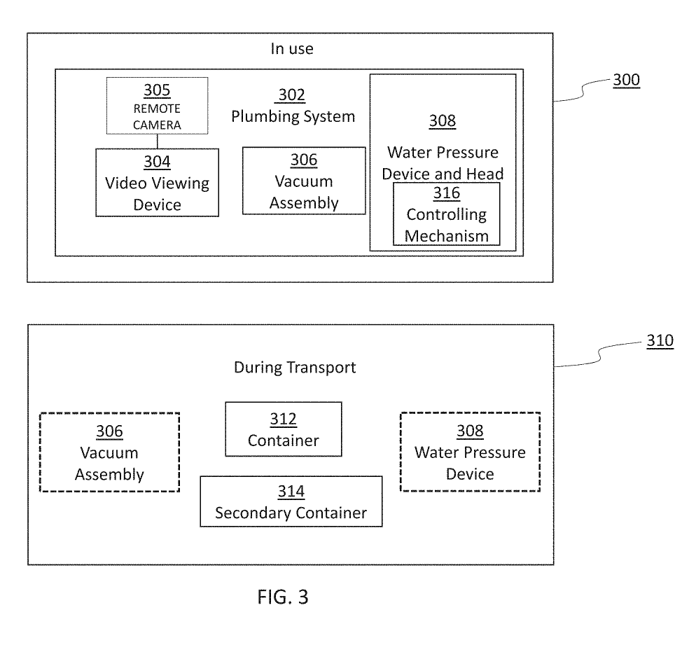

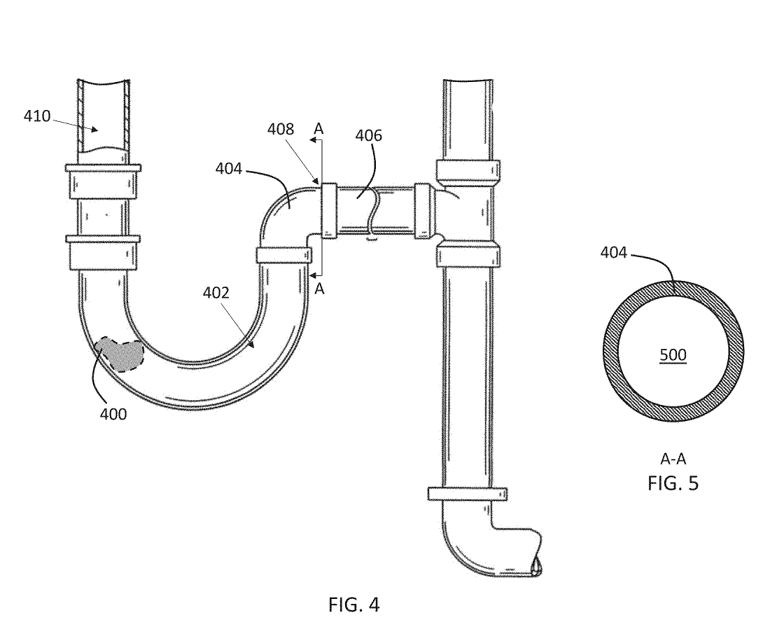

Referring briefly to FIG. 4, described in conjunction with the process flow diagram shown in FIG. 2, a process, in accordance with some embodiments, of removing debris 400 from piping 402 within a high-rise building begins at step 200 and immediately proceeds to step 202 of uncoupling a plurality of plumbing members, e.g., members 404, 406 at a joint 408 in the plumbing system 302 to create an opening 500 (shown in FIG. 5). The plurality of plumbing members 404, 406 may be at least one of a drain extension, a clean out plug, a trap, a tailpiece, or any other structure typically used in a plumbing network or system. In some embodiments, the joint 408 may be a drain flange. The plurality of plumbing members 404, 406 and the joint 408 may vary according to the location their respective locations within the plumbing system 302, i.e., in close proximity to a drain or at a mid-point within the piping. It will be recognized by those of skill in the art that the plumbing shown in FIG. 4 is of a conventional trap for use with, for example, a sink. However, similar techniques described herein can be used in the inventive method of cleaning single stack drain systems as well.

In an embodiment, the opening 500 is defined by the plumbing system 302. More specifically, the opening 500 may be defined by a terminal end of one of the plurality of plumbing members 404, 406 constituting a part of a piping network within the plumbing system 302. It will be obvious to those of skill in the art that the opening 500 in which the components are coupled to or inserted within is that which is estimated as being the closest to the obstruction of debris 400. This may be based on downstream fluid flow or by trial-and-error. The plumbing members 404, 406 distribute fluid, such as water for drinking, throughout the piping within high-rise building, or remove waste from the piping through at least one drain. The system for removing debris from piping within a high-rise building 300 is designed for use with various types of plumbing systems 302, particularly vertical drainage systems such as a cast iron sovent system, having a single stack drainage system configuration, or a conventional sewage system having two stacks, e.g., sewage and ventilation, as would be appreciate by one of ordinary skill in the art.

In some embodiments, the opening 500 is disposed downstream of the terminal end of the plumbing system 302 when coupled in normal operation, i.e., not at a drain, and is created by removing two pipes that are removably couplable together. Advantageously, this configuration permits the creation of the opening 500 without puncturing any piping that may damage the piping or detaching numerous portions of the piping to search for at least a piece of debris 400 within the piping. For example, to create the opening 500, a user can remove a trap without having to remove numerous portions of additional piping. The debris 400 is defined herein as any natural or artificial material or any combination of natural and artificial material including, but not limited to dirt, sludge, garbage, food, hair and any other material capable of obstructing piping. The term “user” is defined herein as a human operator or a programmable machine that may perform the present method through the use of computer software.

Referring now to FIG. 1 in conjunction with FIG. 2A, the process continues to step 204 of coupling a fitting 116 to the opening 500 (shown in FIG. 5) in a water-tight configuration to prevent any leaking. In an embodiment, the fitting 116 is y-shaped. More specifically, the fitting 116 is displayed in FIG. 1 as having a three-port arrangement including at least two free openings, 120, 124 at respective first and second branches. FIG. 1 shows a first free opening 118, a second free opening 120, and a third free opening 124. In another embodiment of the present disclosure, the fitting 116 may incorporate one or more valves therein. The first free opening 118 is operable to removably couple to the opening 500 in the water-tight configuration. The second free opening 120 is operable to receive an end of a vacuum conduit 122 in a fluidly sealed configuration, to prevent any air from leaking when the vacuum is in suction mode while removing the debris 400. The third free opening 124 is operable to receive a portion of the video viewing device 304 inserted therein and a portion of a water conduit 126. In an embodiment, the fitting 116 is made of PVC material. In another embodiment, the fitting 116 may be made with copper, steel, iron, or another durable material used in a plumbing network.

The process continues to step 206 of inserting the portion of the video viewing device 304 into third free opening 124. In some embodiments, the video viewing device 304 includes an arm 128, a lens 130, and a camera 132. The camera 132 is displayed in FIG. 1 as a hand-held camera which can easily be transported to various job sites. In another embodiment, the camera 132 may be a video camera. The arm 128 and lens 130 constitute the portion of the video viewing device 304 inserted into the third free opening 124. More specifically, the video viewing device 304 has a proximal end 134 and a distal end 136. The proximal end 134 includes a display screen 138 and the distal end 136 may include the lens 130. The proximal end 134 is coupled to the distal end 136 by the arm 128. In an embodiment, the arm 128 is flexible, such that the arm can bend when inserted into the third free opening 124. The video viewing device 304, more specifically the arm 128, may also be elongated. The term “elongated” is defined herein as of a length that is longer than the average overall width of a referencing object. In an embodiment, the arm 128 may be at least 3.0 feet in length. In other embodiments, the arm 128 may include an extender to increase the length of the arm 128 outside of this range. The length of the arm 128 may vary depending on the distance between the opening 500 and the location of the debris 400 within a plumbing channel 410 (shown in FIG. 4) defined by the plumbing system 302. The plumbing channel 410 is defined by the inner surface of the piping. In some embodiments, however, the video viewing device can be carried by a head of a flexible fluid conduit that is pressurized, and which has at least one reverse-facing nozzle.

The process continues to step 208, inserting the head of the water conduit 126 operably coupled to the water pressure device 308, into the third free opening 124. In an embodiment, the water conduit 126 includes a hose 142 and a nozzle 144. The hose 142 and nozzle 144 constitute the portion of the water conduit 126 inserted into the third free opening 124. In an embodiment, the hose 142 may be flexible such that the hose 142 can bend when inserted into the third free opening 124. The water conduit 126, more specifically, the hose 142 can also be elongated. In an embodiment, the hose 142 is at least one hundred feet in length and approximately 0.25 inches in width. In another embodiment, the hose 142 may be less than one hundred feet in length and less or more than 0.25 inches in width. The hose 142 can detach from the water pressure device 308 for compact storage and portability. The water pressure device 308 can be transported on a truck or wheeled to various job sites.

In an embodiment, the water conduit 126 is operable to deliver a stream of fluid 146 generated by the water pressure device 308 into the plumbing channel 410. The term “stream” is defined herein as any flow of liquid and is not limited to water. In particular, the head can be moved upstream, vertically, in the vertical draining system, by the force of pressurized water passing out of the one or more reverse-facing nozzles of the head. Thus, the head moves upstream in the vertical drainage system, and as it passes debris, the force of the water under pressure being expelled through the reverse-facing nozzle(s) dislodges debris, which is collected, along with the water, by the vacuum pump. In an embodiment, the stream of fluid 146 is of a non-gaseous substance. In another embodiment, the stream of fluid is water. The non-gaseous substance permits the user to effectively and efficiently dislodge the debris 400. In another embodiment, the water conduit 126 is operable to deliver air, though the delivery of fluid is preferred because the amount and duration of fluid coming from the water pressure device 308 is easier to control than air. In an embodiment, step 208 may include inducing a selectively pulsating stream of fluid 146 through the water conduit 126. The term “pulsating” is defined herein as varying in speed according to the amount of water pressure supplied by the water pressure device 308. The speed and duration of the stream of fluid are controlled by a controlling mechanism 316 (FIG. 3). The controlling mechanism 316 may be an interchangeable switch, button, or knob removably coupled to a distal end of the water conduit and operable to provide predetermined pressure and flow settings and can be used to direct the head in the vertical drainage system using the force of the thrust of the water.

The water pressure device 308 generates the stream of fluid 146. The water pressure device 308 generates the stream of fluid 146 that is not limited to water, rather the stream of fluid 146 is any type of fluid. In an embodiment, the water pressure device 308 is a JM-1450 Electric Jet, operable to generate at least 1500 pounds per square inch (“PSI”) at 1.7 gallons per minute (“GPM”). In another embodiment, the water pressure device 308 is a heavy duty electric pressure washer capable of generating up to 3,000 PSI and 2.5 GPM. In yet another embodiment, the pressure washer is a gas pressure washer capable of generating up to 3,000 PSI and 2.5 GPM. In other embodiments, the water pressure device may be another type of pressure washer, generating a level of PSI and delivering a flow rate outside of the aforementioned ranges. FIG. 1 displays the water pressure device 308 as portable. Advantageously, the portability allows the water pressure device 308 to easily be maneuvered throughout the high-rise building.

The process continues to step 210 of coupling the end of the vacuum conduit 122 to the second free opening 120 in the fluidly sealed configuration. In an embodiment, as displayed in FIG. 1, the vacuum conduit 122 includes a tube 150 and a control valve 152. The tube 150 is inserted into the second free opening 120. The tube 150 removably couples the vacuum conduit 122 to the vacuum assembly 306 at a second end (not shown). The vacuum conduit 122 may also include a transparent surface 154 located proximal to the end of the vacuum conduit 122. In other embodiments, the transparent surface 154 may be located on the fitting 116 or another portion of the vacuum system 306. Advantageously, through the transparent surface 154, the user is able to view the debris 400 as it is removed from the plumbing channel 410. The vacuum assembly 306 is a pumping and vacuum system that operates to remove and transport the debris 400. The control valve 152 turns the vacuum assembly 306 from an “off” mode to an “on” mode for suction. In an embodiment, the vacuum assembly 306 is a CONDE™ ProVac Industrial Pumpout Station. The CONDE™ ProVac Industrial Pumpout Station may be made with steel or aluminum. In some embodiments, the dimensions of the CONDE™ ProVac Industrial Pumpout Station are 24.0 inches in width, 50.0 inches in length, and 45 inches in height. In some embodiments, the CONDE™ ProVac Industrial Pumpout Station has an intake flow rate of 120 GPM with a tank volume of 52.0 gallons. In another embodiment, the vacuum assembly 306 is a standard vacuum. In yet another embodiment, the vacuum assembly 306 is an industrial vacuum. Advantageously, the vacuum assembly 306 can be transported to various job sites.

Referring now to FIG. 1 in conjunction with FIG. 2B, the process continues to step 212 of producing an image 156 or plurality of images of the plumbing channel 410 in real-time. The video viewing device 304 displays the image 156 on the camera 132. More specifically, the lens 130 surveys the plumbing channel 410 so that the image 156 can be viewed on the display screen 138. The video viewing device 304 may also produce a still image of the plumbing channel 410, which can be stored on internal memory or a removable storage medium. Obviously, real-time viewing is preferred so that the user can quickly and efficiently identify the debris 400 within the plumbing channel 410 through the lens 130 and display screen 138. As previously stated herein, the user may be a human operator or programmable machine.

The process continues to step 214 of maneuvering the head and the video viewing device 304 within a vertical drainage system until the image 156 depicts the debris at least partially obstructing the vertical drainage system. In order for the user to quickly produce the stream of fluid into the drainage line, both the video viewing device 304 and the water conduit 126 are maneuvered past the debris, where water from the reverse facing nozzle of the head will dislodge the debris and carry it back downstream to the y-shaped fitting, where it will be collected by the vacuum pump.

Accordingly, once the partial obstruction is identified, the process continues to step 216 of inducing the stream of fluid through the water conduit 126. The stream of fluid is directed at the debris to dislodge the debris. The term “dislodged” is defined herein as forced out of position. The speed of the stream of fluid, i.e., flow rate or GPM, sufficient to dislodge the debris will naturally vary, depending on factors such as the weight, size and type of debris. It may also vary based on the bond that the debris has with the inner surface of the drainage line. In one example, the speed sufficient to dislodge the debris 400 may be up to 1.7 GPM. In another example, the speed may be between 1.7 to 2.5 GPM. In another example, the GPM may be greater than 2.5 GPM to dislodge heavy or large pieces of debris 400 that may be at least partially obstructing the plumbing channel 410.

The process continues to step 218 of inducing a vacuum within the plumbing system 302 sufficient to remove the debris from with the plumbing channel 410. Step 216 may performed any time after step 210 and before step 220. The vacuum is created when the pressure level within the hose 142 drops below the pressure level outside of the hose 142. The amount of pressure induced by the vacuum is controlled by the vacuum assembly 306. In some embodiments, the vacuum assembly 306 is the CONDE™ ProVac Industrial Pumpout Station having an operating vacuum level of 16″ Hg and an operating pressure of 5 PSI. The negative pressure generated by the vacuum is sufficient to remove the debris from the opening 500. Similar to the rate of water flow, the amount of pressure supplied by the vacuum varies, depending on the weight and size of the piece of debris. The amount of pressure supplied by the vacuum may also vary depending on the bond between the debris 400 and the plumbing channel 410.

Referring now to FIG. 3, following the removal of the debris 400, the process continues by housing the debris 400 in the container 312 housed by the vacuum assembly 306. The material of the container 312 is preferably a durable material such as aluminum or steel, which provides the user with the container 312 that is operable to store fluid during the process of removing the debris. Next, the process continues by pumping the debris 400 from the container 312 to a secondary container 314, using a pumping device also housed by the vacuum assembly 306. The secondary container 314 is preferably a portable heavy duty plastic container that can hold at least fifty five gallons of fluid at any given time. Advantageously, this process provides the user with the ability to empty the debris and fluid from the secondary container 314 and continue the process of removing the debris if necessary.

Referring now to FIG. 1 in conjunction with FIG. 2B, the process continues with step 220 of recoupling the plurality of plumbing members 404, 406 after the debris 400 has been removed to create a pre-existing fluidly sealed configuration at the joint 408 in the plumbing system 302 as shown in FIG. 4. The process creates little to no damage to the plumbing system 302 because the process is designed to restore the plumbing members 404, 406 to their pre-existing configuration following the removal of the debris 400. The process ends at step 222.

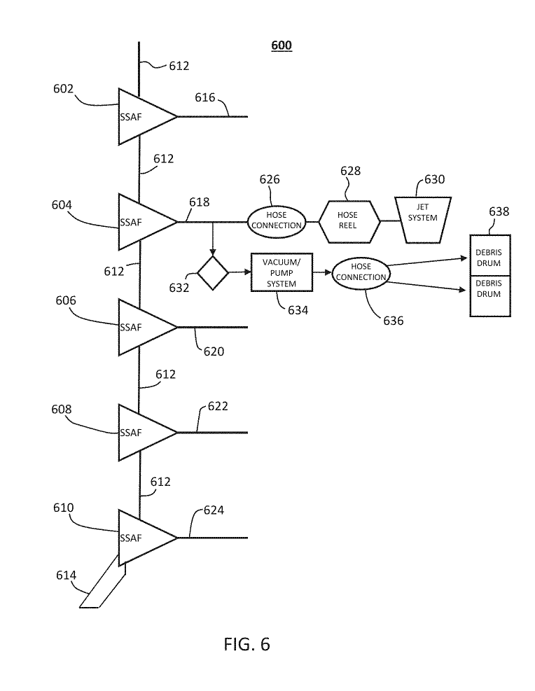

FIG. 6 shows a single stack drainage system 600 in accordance with some embodiments. The single stack drainage system can be a sovent system that uses one vertical pipe line 612 to both aerate and drain on multiple floors of a building. At each floor a single stack aerator fitting element 602, 604, 606, 608, 610 (each on different floors of a building on line 612) is connected in the vertical pipe line 612. Each single stack aerator fitting element 602, 604, 606, 608, 610 is connected to a respective horizontal line 616, 618, 620, 622, 624 for connecting to fixtures on the respective floor, such as sinks, bath drains, etc. At the bottom of the vertical pipe line 612, below the lowest single stack aerator fitting element 610, is a de-aerator 514 fitting.

It has been found that the vent slot that provides aeration in single stack aerator fitting elements can close due to the build up of debris and scale over time. This slows the airflow in the system and waste and debris does not exit the horizontal lines 616, 618, 620, 622, 624 properly, with free flow. This allows debris to lay in the horizontal lines 616, 618, 620, 622, 624. The horizontal lines 616, 618, 620, 622, 624 are typically eight to fifty feet long. This debris slowly turns to a sludge like substance and eventually fills the line and restricts airflow, causing bubbling in the drains and eventually stops flow completely. Passing a conventional clearing cable through a horizontal line 616, 618, 620, 622, 624 does not break up the sludge. The lack of airflow does not allow sludge to pass through the horizontal line 616, 618, 620, 622, 624. If jetting is used in the restricted (sludge-filled) line it moves the sludge into the main line 612 and worsens the problem by moving the sludge into another area of the building. The disclosure removes sludge from the and debris from the vertical line 612 and the vent slot in a single stack aerator fitting element 602, 604, 606, 608, 610 to restore and maintain proper air flow through the vertical line 612 and the horizontal lines 616, 618, 620, 622, 624 by combining jetting and vacuuming at the same time so that debris is not sent into the vertical line 612, which could simply result in stoppages at lower floor.

In some embodiments debris removal is accomplished by connecting a hose connection 626 to a horizontal line, here horizontal line 518. A hose is supplied by a hose reel 628 to carry water under pressure from a jet system 630. An attachment 632 allows a vacuum/pump system 634 to be used to remove debris dislodged by the jet. The pump system 634 pumps sludge through a hose connection 636 to a debris drum or drums 638 or equivalent receptacle.

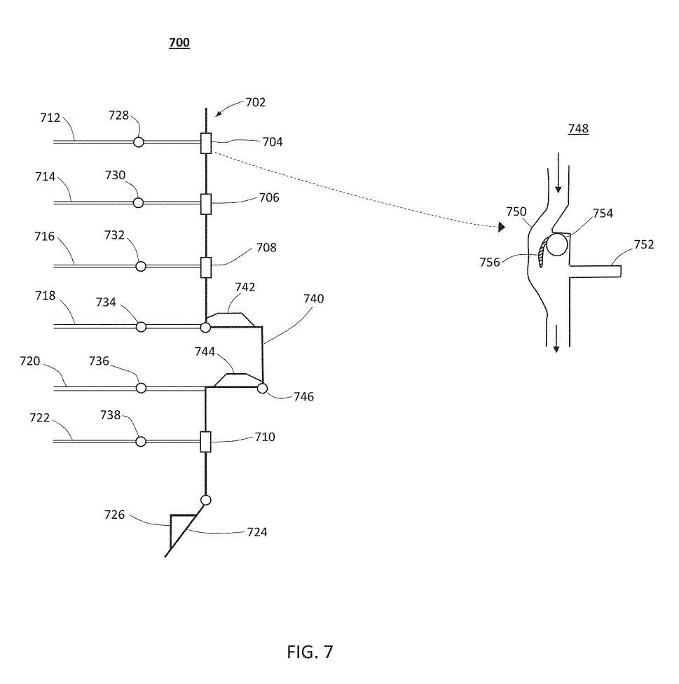

FIG. 7 is a schematic diagram of a single stack system 700 using single stack aerator fittings and horizontal offsets, in accordance with some embodiments. In typical high rise buildings where a single stack system is used, there are horizontal offsets placed in the line every few floors in order to slow down the drainage. In the system 700 there is a single stack line 702 that is a vertical drain line of a building having several stories. The single stack line 702 shown here shows the bottom several stories. At each floor there is a single stack aerator fitting 704, 706, 708, 710, except at floor where an horizontal offset 740 is used (although they could be placed there as well). The horizontal offset includes at least one horizontal run of drain line and an associated de-aerator section. As shown here, there are two horizontal offsets on successive floors, each having a de-aerator section 742 and 744. Each floor has a horizontal drain lines 712, 714, 716, 718, 720, 722 for receiving drainage from fixtures in the living spaces on those floors (e.g. sinks, shower/tub, commode). On each floor there are access ports such as access ports 728, 730, 732, 734, 736, 738, 746. These access ports can be for clean out access. At the very bottom of the stack is the drain connection 724 and an associated de-aerator section 726.

A cross section view of a single stack aerator fitting is shown in detail 748. The detail 748 can represent any of the single stack aerator fittings 704, 706, 708, 710, and can be substantially similar to those known in the industry as a sovent fitting. The single stack aerator fitting includes a deviation section 750 that deviates from the vertical direction slight to impart a directional change to the drainage. A first connection 752 can connect to drains that are typically mostly water (e.g. sink, shower) and a second connection 754 can connect to a commode drain. Inside the single stack aerator fitting is a baffle 756 that allows drainage from the second connection 754 to enter the vertical single stack drain with aeration.

To clean out the vertical line 702, and single stack aerator fittings 704, 706, 708, 710, any of the access ports 728, 730, 732, 734, 736, 738, 746 (or others) can be opened to attach a y-shaped fitting (e.g. 116) to so that a jetted water source can be inserted in the line 702 along with a camera, and a suction/vacuum source and be connected as well. The jetted water source uses a spray head that can be manipulated to direct the head in the line to steer it in a desired direction, allowing an operator to clean out the line 702, or any of the horizontal drain lines 712, 714, 716, 718, 720, 722 through an access port such as access port 746, which can be located in a common area, rather than in a residential unit. Thus, a drain line 702 can be cleaned out without having to enter a residential unit, although it can also be cleaned out from access through a residential unit.

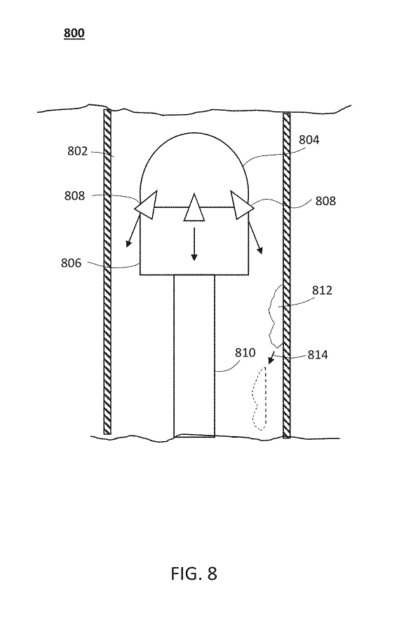

FIG. 8 shows a reverse jet cleaner head used in a single stack system 800, in accordance with some embodiments. The signal stack system includes a vertical line 802 (e.g. a pipe or drain conduit) in which a head 804 is introduced. The head 804 includes several jet nozzles 808 that direct water as indicated by the arrows. The head can be steered by selective actuation of the jet nozzles 808. The head 804 can be coupled to a fitting 806 that is coupled to a water line 810 that is further coupled to a high pressure pump. Water pumped in to the water line 810 under high pressure. The water exits one or more of the jet nozzles 808 to propel the head along the line, vertically as well as horizontally. As the head moves past debris 812, the force of the water under high pressure from the jet nozzles clears the debris 812, and urges it down the line 802, as indicated by arrow 814, where the vacuum system removes it at the y-shaped fitting.

Thus, a method for cleaning drain lines includes providing a water line to which a head is coupled, the head has backward or reverse aimed or oriented nozzles, and water under high pressure (higher than municipal pressure, created by a pump, and high enough to lift the head and water line vertically) is provided to the water line and head. The head can be maneuvered by an operator with the assistance of the camera and viewing device. The camera moves in conjunction with the head in the drainage line. The operator maneuvers the head past debris, and the reverse-aimed nozzles spray with sufficient force to dislodge and urge debris back down the drainage line, along the water line, where it is sucked up by the vacuum pump and routed into a debris container. This method is not used for removing complete blockages as it depends on the head being moved past debris in order to urge is back down (downstream) the drainage line towards the point where the drainage line is being accessed. It will be appreciated by those skilled in the art that there can be a wide variety of head shapes and configurations designed to accomplish cleaning of drain lines as described herein. In some embodiments the head can include forward facing nozzles, so long as the net force of the nozzles is sufficient to push the head upwards along vertical drainage lines and allow the operator to maneuver the head past debris, around corners in the drainage line, into single stack aerator fittings, and so on.

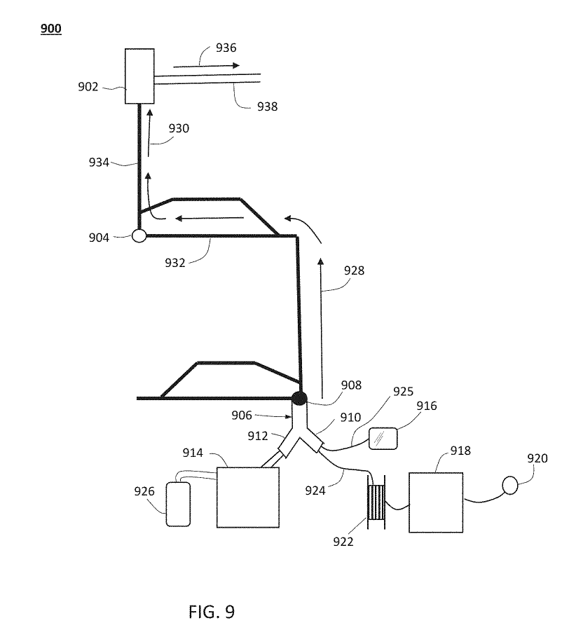

FIG. 9 shows a schematic diagram of a cleaning system and method for cleaning a single stack system 900, vertically, in accordance with some embodiments. The single stack system includes at least one single stack aerator fitting 902, which can be substantially the same as any of the single stack aerator fittings 704, 706, 708, 710 of FIG. 7, which are substantially equivalent to the sovent element 602, 604, 606, 608, 610 of FIG. 6. However, unlike the straight single stack arrangement of FIG. 6, the single stack line 900 includes at least one horizontal offset. The horizontal offset includes one or more access ports 904, 908. A y-shaped fitting 906 is shown connected to access port 908. The y-shaped fitting includes two branches 910, 910. Branch 910 is used to insert a water line 924 and a camera cable 925. At the end of the camera cable 925 that is inserted into the system 900 through branch 910 is a camera and light source that transmits a signal back along the camera cable 925 to a display device 916 so that the operator can see what is in the system 900 at the point along the system 900 where the camera is located. The water line 924 has an end on which is a head having one or more reverse-facing jet nozzles such as that shown in FIG. 8. The head can carry the end of the camera cable in some embodiments. The water line or flexible water conduit can be spooled 922 and connected to a pump 918 that is further connected to a water source 920. The pump creates pressure in the water line 924 that is released through the one or more jet nozzles in the head. Using that pressure, the head can be maneuvered and steered upstream in the system 900 vertically, turned along the top section 932 of the horizontal offset, up the vertical section 934 of the main stack to the single stack aerator fitting 902, as indicated by arrows 928, 930, 936. The head can then be operated to clean out portions of the single stack aerator fitting 902, and can then be operated and steered through the single stack aerator fitting to clean out higher up single stack aerator fittings, or through the horizontal connections 938 (also 752, 754) to clean along horizontal lines as well. The pressure created by the pump 918 is sufficient to cause the head and water line to travel vertically up several stories. In some embodiments the pressure can be in the range of 1500-3000 PSI, which is substantially higher than the pressure provided by the water source 920 (e.g. municipal water pressure). The display device 916 can be used by the operator to maneuver and direct the head in the line as desired using visual feedback. As the water and dislodged debris travel down the single stack line, a vacuum pump 914 pulls the drainage through branch 912 of the y-shaped fitting and deposits it into a debris receptacle 926.

Accordingly, there disclosed a method and system for removing debris in a high rise building plumbing network that can be achieved using both vertical and horizontal access. Pressure is used in conjunction with a camera allow an operated to steer a jetted head up and along drain lines to dislodge debris and urge it down the drain where it is collected in a debris receptacle and can be removed from the premises to be disposed of. By using the vacuum pump, the debris that is removed will not be able to build up in lower portions of the system. This is an advantage when cleaning out drainage lines in high rise buildings by allowing sections of the drainage lines to be cleaned out without impacting the state of lower sections of the drainage line.

What is claimed is:

1. A method of removing debris from a single stack drainage system within a high-rise building, wherein the single stack drainage system includes at least one vertical section including a plurality of single stack aerator fittings, with one single stack aerator fitting at each of a plurality of respective floors of the high-rise building, and wherein each single stack fitting couples to horizontal drain lines at the respective floor, the method comprising:
connecting a y-shaped fitting to an access point connected to the single stack drainage system, the y-shaped fitting having a first branch and a second branch;
after connecting the y-shaped fitting:
inserting a portion of a flexible optical device having a camera into a first one of the first branch of the y-shaped fitting into the single stack drainage system;
inserting a portion of a flexible water conduit into the single stack drainage system through the first branch of the y-shaped fitting, the flexible water conduit having a head, the head having at least one reverse-facing nozzle, the flexible water conduit operably coupled to a pressurized water source that provides water at a pressure sufficient to urge the head vertically upstream in the single stack drainage system when the water passes through the at least one reverse-facing nozzle;
maneuvering the flexible water conduit while providing the water under pressure to the head such that the head travels upstream in the single stack drainage system past debris that is dislodges by the water after passing through the at least one reverse-facing nozzle.

2. The method of claim 1, wherein maneuvering the flexible water conduit comprises maneuvering the flexible water conduit into a single stack aerator fitting in the single stack drainage system.

3. The method of claim 2, further comprising maneuvering the head through the single stack aerator fitting and into a horizontal drain line connected to the signal stack aerator fitting to remove debris from the horizontal drain line.

4. The method of claim 1, wherein maneuvering the flexible water conduit comprises maneuvering the head past a single stack aerator fitting to a vertical section of the single stack drainage system above the signal stack aerator fitting.

5. The method of claim 1, further comprising connecting a vacuum pump to the second branch of the y-shaped fitting to remove water and dislodged debris from the single stack drainage system.

6. The method of claim 5, further comprising pumping the water and dislodged debris into a debris containment vessel.

7. The method of claim 1, wherein the pressurized water source is a pump.

8. The method of claim 1, wherein the head carries the camera.

9. A method of removing debris from a vertical drainage system within a high-rise building, wherein the vertical drainage system includes at least one vertical section including a plurality of vertical aerator connections, and wherein the vertical drainage system couples to at least one horizontal drain line at each floor of the high-rise building, the method comprising:
connecting a y-shaped fitting to an access point connected to the vertical drainage system, the y-shaped fitting having a first branch and a second branch;
after connecting the y-shaped fitting:
inserting a portion of a flexible optical device having a camera into a first one of the first branch of the y-shaped fitting into the vertical drainage system;
inserting a portion of a flexible water conduit into the vertical drainage system through the first branch of the y-shaped fitting, the water conduit having a head, the head having at least one reverse-facing nozzle, the water conduit operably coupled to a pressurized water source that provides water at a pressure sufficient to move the head vertically upstream in the vertical drainage system when the water passes through the at least one reverse-facing nozzle;
maneuvering the flexible water conduit while providing the water under pressure to the head such that the head travels upstream in the vertical drainage system past debris that is dislodges by the water after passing through the at least one reverse-facing nozzle; and
moving the camera in correspondence with the head, and wherein maneuvering the flexible water conduit comprises maneuvering the flexible water conduit based on a video image on a display connected to the camera that is produced by the camera.

10. The method of claim 9, further comprising maneuvering the head into a horizontal drain line upstream of the access point and the at least one vertical section.

11. The method of claim 9, further comprising connecting a vacuum pump to the second branch of the y-shaped fitting to remove water and dislodged debris from the vertical drainage system.

12. The method of claim 11, further comprising pumping the water and dislodged debris into a debris containment vessel.

13. The method of claim 9, wherein the pressurized water source is a pump.

14. The method of claim 9, wherein the head carries the camera.

15. The method of claim 9, wherein the water is pressurized to at least 1500 pounds per square inch.
